(19) United States
(12) Patent Application Publication
(10) Pub. No.: US 2011/0285115 A1
(43) Pub. Date: Nov. 24, 2011

(54) Roof Rail Side Air Bag With Tensioning Tether

(75) Inventors: Brian J. Putala, Milford, MI (US); Kristine E. Lott, Rochester Hills, MI (US)

(73) Assignee: GM GLOBAL TECHNOLOGY OPERATIONS, INC., DETROIT, MI (US)

(21) Appl. No.: 12/785,521

(22) Filed: May 24, 2010

(51) Int. Cl. B60R 21/213; B60R 21/26; B60R 21/16

(52) U.S. Cl. 280/730.2; 280/743.2; 280/741

(57) ABSTRACT

A side airbag has a top edge mounted on the roof rail and is normally furled along the roof rail and stored within a housing. An inflator inflates the airbag so that the airbag unfurls downwardly from the roof rail and across the window opening. A tether is attached to at least one of the front edge and rear edges of the airbag. A tether tensioner mounted on one of the front pillar and rear pillar closest to the edge of the airbag having the tether. The tensioner has a piston slidable therein with a cylinder piston rod attached to the tether. An actuator slides the piston to tension and retract the tether, and a one-way ratchet mechanism locks the piston. Thus the tether will retain the airbag in its inflated position across the window opening and against the occupant force applied thereagainst.

### FIELD OF THE INVENTION

The invention relates to a side airbag mounted on the roof rail and more particularly provides tethers with low-power tensioners for retaining the airbag in its inflated position.

### BACKGROUND OF THE INVENTION

It is known in vehicle bodies to provide an airbag that is mounted on the roof rail above the window opening and stored within a housing. An inflator inflates the airbag causing the airbag to unfurl downwardly across the window glass. The inflation of the airbag by pressurized gas assures the downward unfurling of the airbag, and the door, the side trim and the window glass support the airbag against movement in the direction outwardly of the vehicle. It would be desirable to provide a tethering arrangement that would function to provide additional support for the unfurled airbag to further restrain the airbag against movement in the direction outwardly of the vehicle body, even after the inflation gas has been exhausted.

### SUMMARY OF THE INVENTION

A side airbag is provided for restraining an occupant seated in a vehicle body having window opening that is defined by a roof rail at the top, a front pillar at the front, a rear pillar at the rear, and a windowsill at the bottom. The airbag has a top edge mounted on the roof rail and is normally furled along the roof rail and stored within a housing. An inflator inflates the airbag so that the airbag unfurls downwardly from the roof rail and across the window opening. A tether is attached to at least one of the front edge and rear edge of the airbag. A tether tensioner is mounted on one or both of the front pillar and rear pillar closest to the edge of the airbag having the tether. The tensioner has a piston slidable therein with a cylinder piston rod attached to the tether. An actuator slides the piston to tension and retract the tether and thereby retain the airbag in its inflated position across the window opening and against the occupant force applied thereagainst.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a side elevation view having parts broken away and in section and showing the airbag stored within a housing on the roof rail.

FIG. 2 is a longitudinal section view having parts broken away and in section showing a tensioner in its extended position.

FIG. 3 is a view similar to FIG. 2 but showing the tensioner having been actuated to withdraw the tether attached to the airbag.

FIG. 4 is a view similar to FIG. 1 but showing the airbag inflated and unfurled to provide restraint of the occupant.

### DESCRIPTION OF THE PREFERRED EMBODIMENT

The following description of certain exemplary embodiments is merely exemplary in nature and is not intended to limit the invention, its application, or uses.

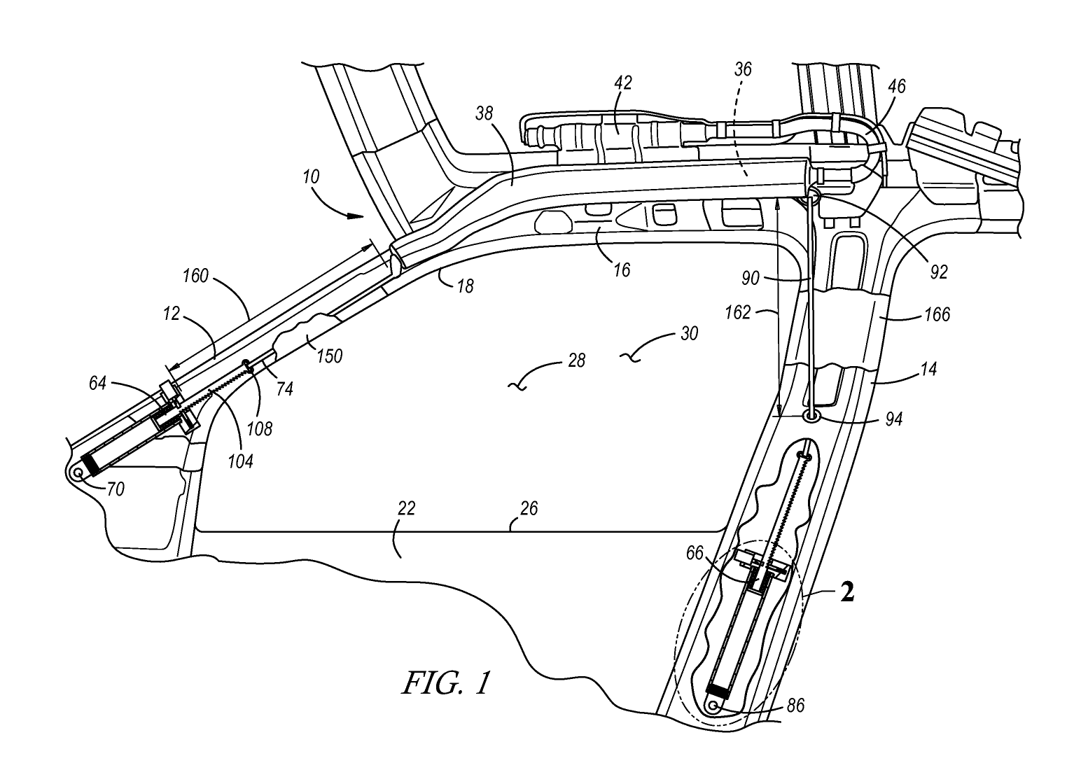

Referring to FIG. 1 a vehicle body is shown generally at 10 and includes a front pillar 12, a rear pillar 14, and a roof rail 16 that cooperate to define a door opening 18. A door 22 is hinged on the front pillar 12 for swinging movement between open and closed positions. The door 22 has a windowsill 26 that defines the lower edge of a window opening 28. Window opening 28 is further defined by the front pillar 12, rear pillar 14, and the roof rail 16. In some vehicles, the door 22 has a window frame that surrounds the window opening 28 and the window frame swings open and closed with the door 22. In other vehicles, such as shown in FIG. 1, the door 22 does not have a window frame and a window glass 30 has edges that bear directly against weather strips mounted the on front pillar 12, rear pillar 14 and roof rail 16.

In FIG. 1 a side airbag 36 has a top edge portion mounted on the roof rail 16 and the airbag 36 is furled or rolled up and stored within an airbag housing 38. A conventional inflator 42 is connected to the stored airbag 36 by a duct 46 and will provide inflation gas to the airbag 36.

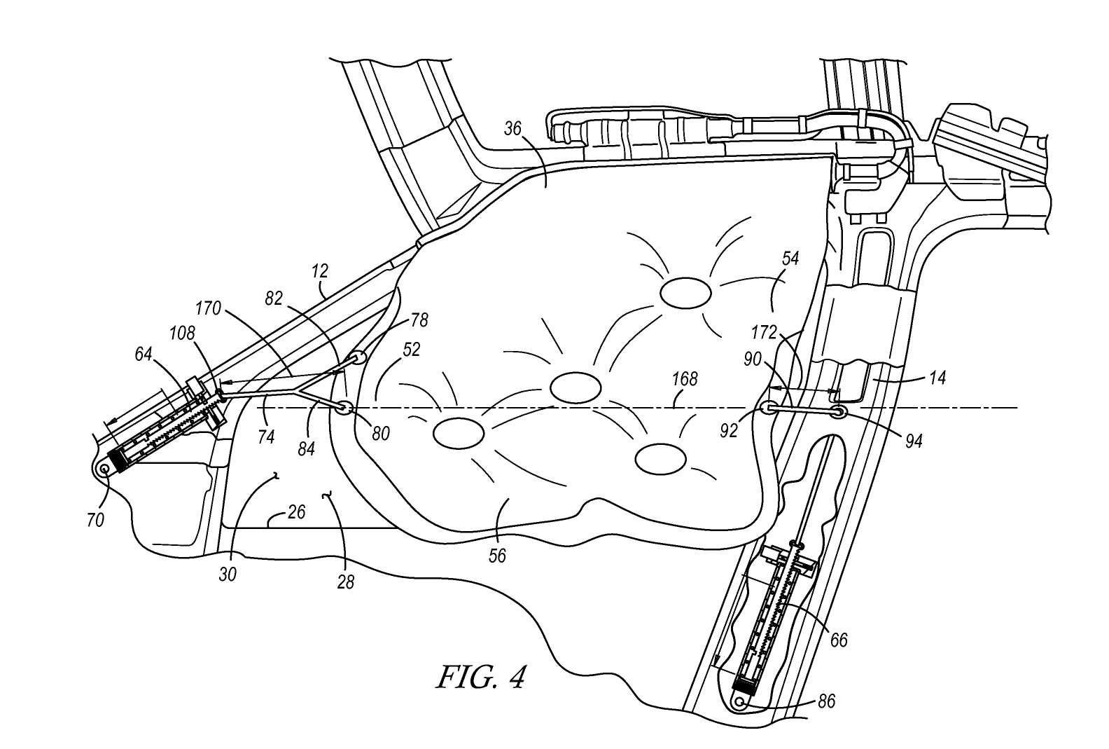

Referring to FIG. 4, it is seen that the airbag 36 has been inflated and unfurled downwardly across the window opening 28. In addition, it is seen that the airbag 36 has a front edge portion 52 that somewhat overlaps the front pillar 12, a rear edge portion 54 that somewhat overlaps the rear pillar 14, and a lower edge portion 56 that somewhat overlaps the windowsill 26. This overlap of the edge portions of the airbag 36 with the pillars 12 and 14 and the windowsill 26, as well as the positioning of the inflated airbag 36 against the window glass 30, will cooperate to restrain the airbag 36 against movement in the direction outwardly of the vehicle.

Referring again to FIGS. 1 and 4 it is seen that a front tensioner 64 is provided at the front of the airbag 36 and a rear tensioner 66 is provided at the rear of the airbag 36. In particular, the front tensioner 64 is mounted on the front pillar 12 by an anchor or mounting bolt 70 and a front tether 74 extends between the front tensioner 64 and the front edge portion 52 of the airbag 36. As best seen in FIG. 4, the front edge portion 52 of the airbag 36 has an upper aperture 78 and a lower aperture 80 provided therein. The tether 74 is a flexible rope or fabric strip-like material that is “Y” shaped and has an upper leg 82 attached to the upper aperture 78 and a lower leg 84 that attaches to the lower aperture 80. The rear tensioner 66 is mounted on the rear pillar 14 by a mounting bolt 86. A rear tether 90 extends between the rear tensioner 66 and an aperture 92 provided in the rear edge portion 54 of the airbag 36. The rear tether 90 passes through a pivot eyelet 94 that is mounted on the rear pillar 14 and will be discussed further hereinafter.

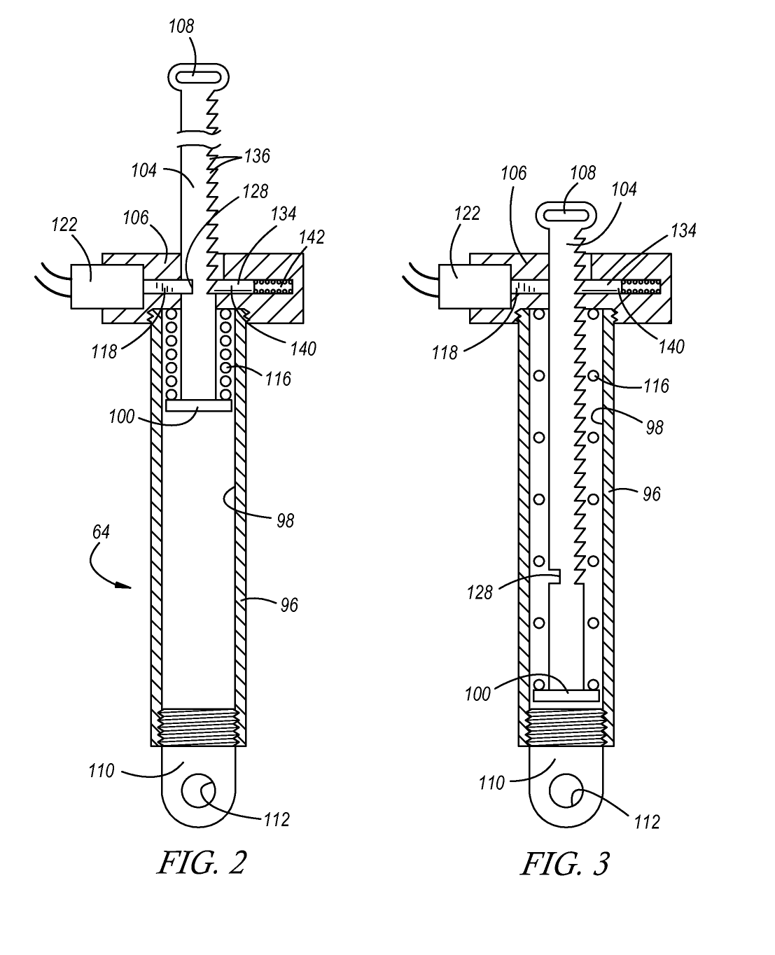

As best seen in FIG. 2, the tensioner 64 includes a cylinder 96 having a bore 98 in which a piston 100 is slidable. The piston 100 carries a piston rod 104 that extends through an upper end cap 106 that is threaded onto the end of the cylinder 96. The end of the piston rod 104 has a pivot eyelet 108 to which the tether 74 is attached. The bottom end of the cylinder 96 is closed by a lower end cap 110 that is threaded into the lower end of the cylinder 96 and has a mounting hole 112 for receiving the mounting bolt 70 that mounts the tensioner 64 to the vehicle front pillar 12.

Furthermore, as seen in FIG. 2, the tensioner 64 has a coil compression spring 116 that surrounds the piston rod 104 and acts between the upper cap 106 and the piston 100 to urge the piston rod 104 in the downward direction. A latch pin 118 is slidable within the upper cap 106 and is operated by a solenoid coil 122. As shown in FIG. 2, the solenoid coil 122 normally positions the latch pin 118 in engagement with a slot 128 provided in the piston rod 104 so that the coil compression spring 116 cannot move the piston rod 104 in the downwardly direction. However, upon energization of the solenoid coil 122, the solenoid coil 122 will withdraw the latch pin 118 from the slot 128 so that the piston rod 104 is permitted to move downwardly in response to the energy stored in the coil compression spring 116. Thus the latch pin 118 and slot 128 act as a latch for latching the piston rod in its extended position, and the coil compression spring 116 functions as an actuator for actuating the retraction or withdrawal of the piston rod into the cylinder to retract, withdraw and tension the tether 74.

FIG. 2 also shows that the tensioner 64 includes a locking mechanism, in particular, a one-way ratchet mechanism 134 that includes a series of ratchet teeth 136 provided along the length of the piston rod 104, and a ratchet pawl 140 that is slidable within the upper cap 106 and biased by a ratchet spring 142. As seen in FIG. 2, the teeth 136 on the piston rod 104 are configured to cooperate with the ratchet pawl 140 in a manner that will permit the ratchet pawl 140 to ratchet over the teeth 136 as the piston rod 104 is moved downwardly by the coil compression spring 116. However, as seen in FIG. 3, the ratchet pawl 140 will prevent the piston rod 104 from moving upwardly from its FIG. 3 position in which the piston rod 104 has been withdrawn into the cylinder 96 by the extension of the coil compression spring 116.

Referring again to FIGS. 1 and 4, it is seen that the tensioner 64 is mounted on the front pillar 12 forwardly of the door opening 18 and with the axis of the tensioner 64 extending generally parallel with the front pillar 12. In FIG. 1, it is seen that tether 74 will be concealed beneath a plastic cover 150 that is mounted on the front pillar 12. Also in FIG. 1, the tether 74 has a working length designated 160 as the tether 74 reaches along the length of the front pillar 12 between the apertures 78 and 80 of the stored airbag and the pivot eyelet 108 of the tensioner 64.

Also, FIGS. 1 and 4 show that the rear tensioner 66 is mounted on the rear pillar 14 by the mounting bolt 86 such that the tensioner 66 is mounted on the rear pillar 14 at an elevation below the windowsill 26. The rear tensioner 66 is constructed the same as the front tensioner 64 shown in FIGS. 2 and 3. As seen in FIG. 1, the rear tether 90 extends inside the rear pillar 14 and extends through the pivot eyelet 94 mounted on the rear pillar 14. The pivot eyelet 94 is shown as a simple nylon bushing that is press fit into the rear pillar 14. Alternatively the pivot eyelet 94 can be a pulley or loop or other tether redirecting device. As seen in FIG. 1, the tether 74 has a working length designated 162 as the tether 74 reaches along the length of the rear pillar 14 between the rear tensioner 66 and the aperture 92 of the rear edge portion 54 of the airbag 36. Thus the rear tether 90 extends generally parallel with the rear pillar 14 and can be readily concealed beneath the plastic cover 166 that is mounted on the rear pillar 14.

As seen in FIG. 4, the airbag has been unfurled downwardly by the airbag inflation gas, thus achieving the deployed position of FIG. 4 where the airbag 36 is somewhat overlapping with the front pillar 12, rear pillar 14 and the windowsill 26, and lying against the window glass 30. Upon the inflation of the airbag 36, the front tensioner 64 and the rear tensioner 66 are activated by actuating the solenoid coil 122, thereby allowing the coil compression spring 116 to extend and withdraw the piston rod 104 downwardly into the cylinder 96. Thus, the front tensioner 64 has been actuated to take up and retract the front tether 74 to a working length designated 170 so that the front tether 74 pivots about the pivot eyelet 108 and the front tether 74 now extends generally horizontally between the front edge portion 52 of the airbag and the pivot eyelet 108 which has been fully retracted from its extended position of FIG. 1 to its retracted position of FIG. 4. Thus, it is important to note that the pivot eyelet 108 has acted as a pivot for the front tether 74 and has allowed the tether 74 to pivot from its FIG. 1 position extending generally parallel with the front pillar 12 when the air bag is stored, to its FIG. 4 position in which the tether 74 is now acting in the generally horizontal direction in order to most effectively anchor the forward portion 52 of the airbag 36 against movement in the direction outwardly of the vehicle.

In addition, as seen in FIG. 4, the rear tensioner 66 has been actuated to take up and retract the rear tether 90 to a working length designated 172. The rear tether 90 has pivoted about the pivot eyelet 94 and the rear tether 90 now extends generally horizontally between the rear edge portion 54 of the airbag 36 and the pivot eyelet in order to most effectively anchor the rearward portion of the airbag 54 against movement in the direction outwardly of the vehicle.

Thus, by comparing FIG. 1 with FIG. 4, it is seen that the downward deployment of the airbag has been accommodated by the swinging or pivoting of the front tether 74 about the pivot eyelet 108 of the front tensioner 64, and the swinging of the rear tether 90 about the pivot eyelet 94 associated with the rear tensioner 66. The front tensioner 64 and the rear tensioner 66 have cooperated to retract and shorten the length of the front tether 74 and the rear tether 90 so that the tethers 74 and 90 will effectively retain the airbag 36 at the deployed position of FIG. 4.

Furthermore, as best seen in FIG. 4, it is appreciated that the pivot eyelet 94 for the rear tether and the pivot eyelet 108 of the front tether are generally at the same elevation as one another so that the front tether 74 and the rear tether 90 are generally aligned with one another along the horizontal axis 168 shown in FIG. 4 so that the front edge portion 52 of the airbag is being tensioned in the forwardly direction and the rear edge portion 54 of the airbag is being tensioned in the rearward direction.

It will be appreciated that the spring powered tensioner shown herein can employ a spring having a relatively low spring force as the spring functions to move the piston and the tether and is not required to forcibly move the airbag to the deployed position because the airbag is conventionally deployed by the inflation gas. Thus the function of the tensioner is to remove the slack from the tethers and then retain the tether in their retracted and withdrawn positions to thereby retain the airbag at its deployed position.

Furthermore, although the drawings herein show the example of a tensioner has an actuator that withdraws the tether via the linear pulling of the end of the tether, a rotary tensioner may be employed in which the end of the tether is wound upon a reel. In addition, whether the tensioner is a linear device as shown herein or a rotary device, the tensioner may be actuated and powered by a spring, a motor, a linear solenoid, a stored gas, or a pyrotechnic charge. In each case, a locking or ratcheting device is employed to assure one-way movement of the tensioner so that once the tether is withdraw, the tether will be retained in the withdrawn condition and thereby firmly hold the airbag in its inflated condition.

As seen in FIG. 1, the tethers are normally concealed beneath the plastic covers 150 and 166 that cover the front pillar 12 and the rear pillar 14. Upon inflation of the air bag 36 and tensioning of the tethers, the tethers are released from beneath the plastic covers 150 and 166.

The drawings show the example of the front tether 74 pivoting about the pivot eyelet 108 provided directly on the piston rod 104, and the rear tether 90 pivoting about the pivot eyelet 94 mounted on the rear pillar 14. The use of the pivot eyelet 94 mounted on the pillar has the advantage of permitting the tensioner to be located more remote from the horizontal axis 168. Thus the pivot eyelet can be provided directly on the tensioner or remote from the tensioner as may be desired depending upon the structure and other design consideration of a particular vehicle installation.

Furthermore, although the drawings herein show the invention installed in a front seat, adjacent the passenger door, it will understood that the invention can be employed in a rear seat, and the window opening can be provided within a rear door or in the rear side panel of the vehicle body if there is no rear door.

Thus it is seen that the invention has provided a new and improved airbag tethering arrangement in which a tensioning device is employed to effectively restrain the side airbag in its deployed position even after the gas may have exhausted from the airbag and whether the window glass is open or closed.

What is claimed is:

1. A side airbag for restraining an occupant seated in a vehicle having a window opening defined by a roof rail at the top, a front pillar at the front, a rear pillar at the rear, and a windowsill at the bottom, comprising:
an inflatable air bag having a top edge mounted on the roof rail and a lower edge and front edge and rear edge, said air bag being normally furled and stored along the roof rail within a housing;
an inflator for inflating the air bag so that air bag unfurls downwardly from the roof rail and across the window opening;
a tether attached to one of the front edge and rear edge of the air bag and extending parallel with the pillar when the airbag is stored;
a tether tensioner mounted on the one of the front pillar and rear pillar closest to the edge of the air bag having the tether, said tensioner acting upon inflation of the air bag to retract the tether;
and a locking mechanism associated with the tensioner to prevent extension of the retracted tether so that the tether holds the air bag across the window opening against occupant force applied thereagainst even after the airbag is uninflated.

2. The side air bag of claim 1 further comprising said tensioner including a piston slidable within a cylinder, a piston rod attached to the tether so that sliding of the piston retracts the tether, and an actuator for sliding the piston.

3. The side air bag of claim 1 further comprising said tensioner being a rotating reel having the tether attached thereto and the reel rotating to wind up and retract the tether.

4. The side air bag of claim 2 further comprising said actuator for sliding the piston being a spring housed within the cylinder.

5. The side air bag of claim 2 further comprising said actuator for sliding the piston being a compression spring housed within the cylinder and being compressed to store energy therein, and said tensioner having a latch pin for latching the piston in an extended position in which the tether is not being tensioned by the spring

6. The side air bag of claim 5 further comprising said latch including a solenoid that is operated in response to inflation of the air bag to unlatch the latch pin and enable the piston to be withdrawn within the cylinder by the energy stored in the spring to thereby retract the tether.

7. The side air bag of claim 2 further comprising said locking mechanism being a one-way ratchet acting between the piston rod and the cylinder to enable the piston to slide within the cylinder in only one direction in which the tether is retracted.

8. The side air bag of claim 7 further comprising said one-way ratchet being a plurality of teeth displayed along the piston rod, and a spring loaded ratchet pawl mounted on the cylinder and engaging with the teeth.

9. The side air bag of claim 2 further comprising said actuator for sliding the piston being a compression spring housed within the cylinder and being compressed to store energy therein, and said tensioner having a latch for latching the piston in an extended position in which the tether is not being tensioned by the spring, and said tensioner having a one-way ratchet pawl acting between the piston rod and the cylinder to enable the piston to slide within the cylinder in only one direction in which the tether is retracted.

10. The side air bag of claim 9 further comprising said latch including a solenoid that is operated in response to inflation of the air bag to unlatch the latch and enable the piston to be withdrawn within the cylinder by the energy stored in the spring to thereby retract the tether.

11. The side air bag of claim 10 further comprising said one way ratchet being a plurality of teeth displayed along the piston rod, and a spring loaded ratchet mounted on the cylinder and engaging with the teeth.

12. The side airbag of claim 1 further comprising said tensioner having the tether attached to a piston slidable in a cylinder or attached to a rotating reel, and the tensioning of the tether being actuated and powered by a spring, a motor, an electrical solenoid coil, a stored gas, or a pyrotechnic charge acting upon the piston or reel.

13. A side airbag for restraining an occupant seated in a vehicle having a window opening defined by a roof rail at the top, a front pillar at the front, a rear pillar at the rear, and a windowsill at the bottom, comprising:
a inflatable air bag having a top edge mounted on the roof rail and a lower edge and front edge and rear edge, said air bag being normally furled and stored along the roof rail within a housing;
an inflator for inflating the air bag so that air bag unfurls downwardly from the roof rail and across the window opening;
a front tether attached to the front edge of the air bag;
a rear tether attached to the rear edge of the air bag;
a front tether tensioner mounted on the front pillar and having a piston slidable within a cylinder, a piston rod attached to the front tether, and an actuator for sliding the piston to tension and retract the front tether and retain the inflated position of the air bag against occupant force applied there against;
a rear tether tensioner mounted on the front pillar and having a piston slidable within a cylinder, a piston rod attached to the front tether, and an actuator for sliding the piston to tension and retract the rear tether and retain the inflated position of the air bag against occupant force applied thereagainst.

14. The side air bag of claim 13 further comprising said tensioners each having a spring housed within the cylinder.

15. The side air bag of claim 13 further comprising each of the tensioners having a compression spring housed within the cylinder and being compressed to store energy therein, and said tensioner having a latch for latching the piston in an extended position in which the tether is not being tensioned by the spring.

16. The side air bag of claim 15 further comprising said latch including a solenoid that is operated in response to inflation of the air bag to unlatch the latch and enable the piston to be withdrawn within the cylinder by the energy stored in the spring to thereby retract the tether

17. The side air bag of claim 13 further comprising a one-way ratchet acting between the piston rod and the cylinder to enable the piston to slide within the cylinder in only one direction in which the tether is retracted.

18. The side air bag of claim 17 further comprising said one-way ratchet being a plurality of teeth displayed along the piston rod, and a spring loaded ratchet mounted on the cylinder and engaging with the teeth.

19. The side air bag of claim 13 further comprising said actuator for sliding the piston being a compression spring housed within the cylinder and being compressed to store energy therein, and said tensioner having a latch for latching the piston in an extended position in which the tether is not being tensioned by the spring, and said tensioner having a one-way ratchet acting between the piston rod and the cylinder to enable the piston to slide within the cylinder in only one direction in which the tether is retracted.

20. A side airbag for restraining an occupant seated in a vehicle having a window opening defined by a roof rail at the top, a front pillar at the front, a rear pillar at the rear, and a windowsill at the bottom, comprising:
an inflatable air bag having a top edge mounted on the roof rail and a lower edge and front edge and rear edge, said air bag having a stored position in which the airbag is furled and stored along the roof rail within a housing;
an inflator for inflating the air bag so that air bag unfurls downwardly from the roof rail and across the window opening to a deployed position;
a front tether attached to the front edge of the air bag and extending along the front pillar;
a rear tether attached to the rear edge of the air bag and extending along the rear pillar;
a front tether tensioner mounted on the front pillar and having a piston slidable within a cylinder, a piston rod carrying a pivot eyelet to which the tether is attached, and an actuator for sliding the piston to tension and retract the tether and retain the inflated position of the air bag against occupant force applied there against, said pivot eyelet permitting the tether to be redirected from extending along the front pillar to extending horizontally between the pivot eyelet and the airbag;
a rear tether tensioner mounted on the rear pillar and having a piston slidable within a cylinder, a piston rod attached to the tether, and an actuator for sliding the piston to tension the tether;
and a pivot eyelet mounted on the rear pillar and slideably receiving the tether and permitting the rear tether to be redirected from extending along the rear pillar when the airbag is stored to extending horizontally between the pivot eyelet and the airbag rear portion when the airbag is deployed;
whereby the front and rear tethers retain the airbag in the deployed position against occupant force applied thereagainst.
